(19) United States
(12) Patent Application Publication
(10) Pub. No.: US 2008/0147500 A1
(43) Pub. Date: Jun. 19, 2008

(54) Serving advertisements using entertainment ratings in a collaborative-filtering system

(76) Inventors: Malcolm Slaney, Palo Alto, CA (US); Ben Marlin, Ottawa (CA)

Correspondence Address: STATTLER - SUH PC, 60 SOUTH MARKET STREET, SUITE 480, SAN JOSE, CA, 95113, US

(21) Appl. No.: 11/640,160

(22) Filed: Dec. 15, 2006

(51) Int. Cl. G06Q 30/00

(52) U.S. Cl. 705/14

(57) ABSTRACT

A collaborative-filtering based combination model is used to select advertisements to serve to a current network user. The combination model comprises a plurality of vectors, each vector comprising ratings for entertainment items and ratings for advertisements (or advertisement categories) from a previous network user. A vector may also include ratings for demographic information of the previous network user. Upon receiving one or more entertainment item ratings (and optionally demographic ratings) of a current user, the combination model is used to select one or more advertisements to serve to the current user. A representative vector in the combination model is determined having entertainment item ratings (and optionally demographic ratings) that are most similar to the corresponding entertainment item ratings (and optionally demographic ratings) of the current user. The advertisement/advertisement category ratings of the representative vector are examined to select the advertisements to serve to the current user.

### FIELD OF THE INVENTION

The present invention is directed towards the field of collaborative-filtering based systems, and more particularly toward serving advertisements using entertainment ratings in a collaborative-filtering system.

### BACKGROUND OF THE INVENTION

Currently, entertainment-based webpages provide a wide variety of entertainment content to users. Examples of entertainment content include streaming or downloaded music and videos, articles or images related to music and videos, etc. In addition to the entertainment content, the entertainment-based webpages also provide advertisements for products or services that may be of interest to a user. Entertainment content providers receive revenue from advertisers who wish to have their advertisements displayed to users and typically pay a particular amount each time a user clicks on one of their advertisements.

The need for determining which advertisements to serve to a user is important in improving the user experience of a webpage and in maximizing advertiser revenue. A variety of methods may be employed to determine which advertisements to display to a user. For example, the content of a particular webpage may be used or search terms provided by a user may be used to determine which advertisements to display. However, developing software that can accurately comprehend entertainment content of a webpage has proven difficult and often search terms are not provided by users of entertainment-based webpages. As such, there is a need for a method for selecting advertisements to serve to a user using different types of information.

### SUMMARY OF THE INVENTION

In some embodiments, an advertisement system implements a collaborative-filtering based combination model to predict advertisements that a current network user may have interest using preference information (ratings) of entertainment items and advertisements collected from a plurality of previous network users. Examples of entertainment items include items related to music, music videos, television programs, radio programs, movies/film, or computer/video games.

The combination model comprises a plurality of user vectors, each user vector comprising ratings for one or more entertainment items and ratings for one or more advertisements (or advertisement categories) from a particular previous network user. In other embodiments, a user vector also includes ratings for one or more pieces of demographic information of the particular previous network user. In some embodiments, the combination model is processed to reduce the amount of data in the combination model (e.g., by clustering user vectors to produce a smaller number of vectors).

Upon receiving some preference information from a current network user regarding one or more entertainment items, the advertisement system implements the combination model to select one or more advertisements to serve to the current user. For example, the advertisement system may determine a vector (representative vector) in the combination model having entertainment item ratings (and in some embodiments, demographic ratings) that are most similar to the corresponding entertainment item ratings (and in some embodiments, demographic ratings) of the current user. The advertisement/advertisement category ratings of the representative vector are then examined to determine one or more advertisements to serve to the current user. For example, the advertisements/advertisement categories having the highest rating values may be selected for serving to the current user.

The combination model provides correlations between user preferences/tastes regarding entertainment items (e.g., songs, films, etc.) and preferences/tastes regarding advertisements. For example, the combination model may show that users that prefer heavy metal music prefer particular types of advertisements and users that prefer classical music prefer other types of advertisements. Such correlations are useful in determining which advertisements to serve to other users having similar preferences/tastes in entertainment items, especially where such advertisements are not related to entertainment items, since such correlations would otherwise not be determinable. In some embodiments, one or more advertisements/advertisement categories included in the combination model are not related (in topic or subject) to the entertainment items included in the combination model. As such, the combination model provides correlations between user preferences/tastes regarding entertainment items and preferences/tastes regarding advertisements/advertisement categories unrelated (in topic or subject) to entertainment items.

### BRIEF DESCRIPTION OF THE DRAWINGS

The novel features of the invention are set forth in the appended claims. However, for purpose of explanation, several embodiments of the invention are set forth in the following figures.

FIG. 1 shows a network environment in which some embodiments operate.

FIG. 2 shows a conceptual diagram of a system for producing a combination model for a collaborative-filtering based advertisement system

FIG. 3 shows an example of a combination model comprising a plurality of user vectors having ratings for entertainment items and advertisements/advertisement categories.

FIG. 4 shows an example of a combination model comprising a plurality of user vectors having ratings for ratings for entertainment items, demographic information, and advertisements/advertisement categories.

FIG. 5 is a flowchart of a method for producing a combination model for selecting advertisements to serve.

FIG. 6 is a conceptual diagram of an advertisement system for implementing the combination model for serving one or more advertisements to a current network user.

FIG. 7 is a flowchart of a method for implementing the combination model for serving one or more advertisements to a current network user.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

Background references related to the below description include:

Duda, Hart and Stork, “Pattern Classification,” Wiley-Interscience, 2nd edition, 2001;

Marlin, B., “Collaborative Filtering: A Machine Learning Perspective,” Master of Science Thesis, Graduate Department of Computer Science, University of Toronto, 2004; and

Kleinberg, J. and Sandler, M., “Using Mixture Models for Collaborative Filtering,” In Proceedings of the Thirty-Sixth Annual ACM Symposium on Theory of Computing (Chicago, Ill. USA, Jun. 13-16, 2004).

In the discussion below, Section I provides a general description of a network environment in which some embodiments operate. Section II describes a method for creating a collaborative filtering-based combination model using preference information (ratings) of entertainment items and advertisements collected from network users. Section III describes a method for implementing the combination model for serving one or more advertisements to a current network user.

### I. Network Environment

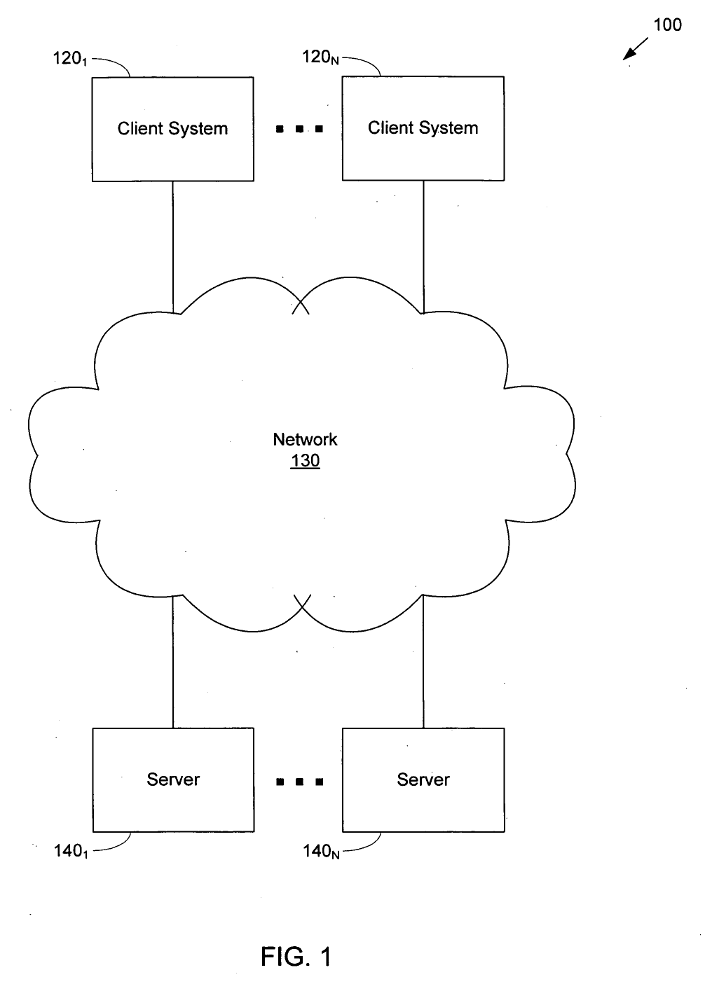

FIG. 1 shows a network environment 100 in which some embodiments operate. The network environment 100 includes a plurality of client systems 120₁ to 120_{N} connected to a network 130 (such as the Internet or an intranet, an extranet, a virtual private network, a non-TCP/IP based network, any LAN or WAN, or the like) and server systems 140₁ to 140_{N}. A server system may include a single server computer or number of server computers.

A server system 140 may provide, to users of the client systems 120₁ to 120_{N}, entertainment-based websites/webpages that provide entertainment content relating to entertainment items. As used herein, entertainment items represent items related to entertainment or art (e.g., music, music videos, television programs, radio programs, movies/film, or computer/video games). An entertainment item may represent a specific entertainment product or service, such as a specific song, album, music video, television or radio program, film, or computer/video game. An entertainment item may also represent broader concepts such as an entertainment artist (e.g., in music, videos, television, film, etc.) or a particular genre or category of entertainment, such as a particular genre/category of music, video, television, or film.

Entertainment content related to entertainment items are provided in a variety of forms on a webpage, such as streaming audio or video, downloaded audio or video, text (such as articles), images, hyperlinks, etc. The webpage may be formatted according to the Hypertext Markup Language (HTML), the Extensible Markup Language (XML), Standard Generalized Markup Language (SGML), or any other language. For example, entertainment content for a particular song (entertainment item) may comprise streaming or downloaded content, and/or text, images, or hyperlinks related to the particular song. As used herein, for purposes of clarity, an entertainment item may also refer to any entertainment content related to the entertainment item. For example, for an entertainment item that is a particular song, the term “entertainment item” may also be used to refer to a downloadable form of the particular song, or an article or hyperlink related to the particular song (i.e., the entertainment content related to the particular song). For example, “selecting/clicking the entertainment item” indicates selecting/clicking any entertainment content related to the entertainment item.

The client system 120 is configured to communicate with any of server systems 140₁ to 140_{N}, for example, to request and receive entertainment content. The client system 120 may include a desktop personal computer, workstation, laptop, PDA, cell phone, any wireless application protocol (WAP) enabled device, or any other device capable of communicating directly or indirectly to a network. A client system 120 typically includes one or more user interface devices (such as a keyboard, a mouse, or the like) for interacting with a graphical user interface (GUI) of a web browser on a display (e.g., monitor screen, LCD display, etc.). As used herein, the terms user and client system may be used interchangeably. As used herein, a user/client system 120 is considered “active on a network” when it is interacting with a server on a network (such as servers 140₁ to 140_{N} on the network 130).

The client system 120 typically runs a web browsing program allowing a user of the client system 120 to interact with server systems 140₁ to 140_{N} over network 130 to perform various user events in relation to an entertainment item, a user event comprising any of a plurality of different user interactions with a server. Such user events include submitting a search relating to an entertainment item (searching for an entertainment item), selecting/clicking on a hyperlink relating to an entertainment item (clicking on an entertainment item), receiving/viewing information relating to an entertainment item (viewing on an entertainment item), and submitting a purchase order for an entertainment item (purchasing an entertainment item) through interaction with one or more server systems 140₁ to 140_{N}.

In addition to entertainment content, the server system 140 may provide, to users of the client systems 120₁ to 120_{N}, advertisements for products or services that may be of interest to the users. Operators of a server system 140 receive revenue from advertisers who wish to have their advertisements displayed to users and typically pay a particular amount each time a user clicks on one of their advertisements. In some embodiments, the client systems 120₁ to 120_{N} and/or system servers 140₁ to 140_{N} are configured to perform the methods described herein. The methods of some embodiments may be implemented in software or hardware to select advertisements for serving.

### II. Creating a Collaborative Filtering-Based Combination Model

In some embodiments, an advertisement system implements a collaborative-filtering based combination model to predict advertisements that a current network user may have interest using preference information (ratings) of entertainment items and advertisements collected from a plurality of previous network users. The advertisement system implements the model to select one or more advertisements to serve to the current user upon receiving some preference information from the current user regarding one or more entertainment items. As such, the advertisement system selects advertisements that are specific to a particular user, but uses information gathered from many other users.

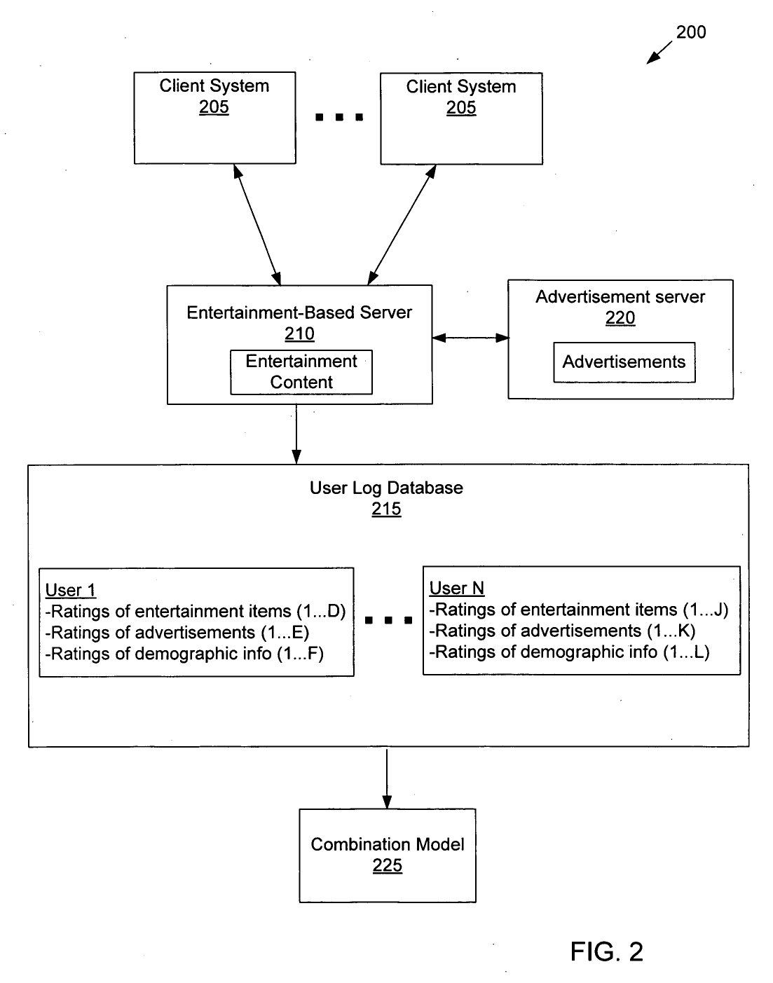

FIG. 2 shows a conceptual diagram of a system 200 for producing a combination model for a collaborative-filtering based advertisement system. The system 200 includes a plurality of client systems 205, an entertainment-based server 210, a user log database 215, an advertisement server 220, and a combination model 225. Various portions of the system 200 may reside in one or more servers (such as servers 140₁ to 140_{N}).

The entertainment-based server 210 stores a plurality of entertainment-based webpages (having entertainment content relating to entertainment items) and is configured to receive webpage requests and retrieve and send the requested webpages to the plurality of client systems 205. The entertainment-based server 210 is also configured to retrieve and send advertisements from the advertisement server 220 to the plurality of client systems 205. The advertisement server 220 stores a plurality of advertisements, each advertisement being associated with an identifier that uniquely identifies the advertisement. The plurality of advertisements may be organized or subdivided by category or taxonomy. For example, a category of advertisements may include advertisements by a specific advertiser (e.g., advertisements by shoe company X). As a further example, a category of advertisements may include advertisements of a specific product or specific style of product. For example, a category of advertisements may include automobiles advertisements or advertisements for a specific style of automobile (e.g., foreign sports cars, family cars, compact cars, etc.).

The client system 205 is configured (e.g., via a web browsing program) to interact with a user to receive ratings of entertainment items from the user and perform user events initiated by the user. The client system 205 is further configured to interact with the entertainment-based server 210 over a network to transmit the user ratings and perform the user events.

For example, the client system 205 may interact with webpages stored on the entertainment-based server 210 to provide explicit ratings for various entertainment items (such as providing 0 to 5 rating values for songs). Also, the client system 205 may interact with webpages stored on the entertainment-based server 210 to perform various user events in relation to various entertainment items. Examples of user events include submitting/performing a search relating to an entertainment item (searching for an entertainment item), selecting/clicking on a hyperlink relating to an entertainment item (clicking on an entertainment item), receiving/viewing information relating to an entertainment item (viewing on an entertainment item), submitting a purchase order for an entertainment item (purchasing an entertainment item), printing an entertainment item, listening to an entertainment item, downloading an entertainment item, etc. through interaction with the entertainment-based server 210. The user/client system 205 may also interact with advertisements received from the entertainment-based server 210 to perform various user events in relation to the advertisements. For example, the user/client system 205 may select/click advertisements received from the entertainment-based server 210.

The entertainment-based server 210 receives, from a plurality of network users/client systems 205, explicit user ratings and user events regarding a plurality of entertainment items and advertisements. As discussed above, explicit ratings of entertainment items comprise rating values given directly by a user for particular entertainment items (e.g., a 0 to 5 star rating for a song, album, music video, film, etc.).

In contrast, implicit ratings of entertainment items comprise rating values that are derived from user events performed by the user (such as clicks, views, purchases, searches, etc.) in relation to entertainment items. Particular user events in relation to an entertainment item are considered to be indicative of a user's preference towards the entertainment item (where such user events imply the user is partial to the entertainment item or advertisement). These user events in relation to an entertainment item can be used to derive an implicit rating for the entertainment item. For example, a relatively high number of selections/clicks on an entertainment item by a user may be converted to a relatively high implicit rating value for the entertainment item by the user. User events can be converted to implicit ratings using various methods known in the art which are not discussed in detail here. For a particular user, the derived implicit rating for a particular entertainment item may be considered along with any explicit rating received from the particular user to determine a single rating for the particular entertainment item for the particular user.

Implicit ratings of advertisements comprise rating values that are derived from user events performed by a user in relation to advertisements. For example, a relatively high click-through-rate (CTR) on an advertisement by a user may be converted to a relatively high implicit rating value for the advertisement by the user. As known in the art, the click-through-rate of an advertisement by a user represents the number of times the user selected/clicked the advertisement divided by the number of times the user received the advertisement. The click-through-rate also reflects the probability or propensity that a particular user will click on the advertisement upon receiving the advertisement. In other embodiments, an implicit rating for an advertisement category (rather than a specific advertisement) is determined for a user that is derived from all user events related to all advertisements in the advertisement category. For example, an implicit rating for sports car advertisements may be determined for a user, the implicit rating reflecting the number of times the user clicked on any sports car advertisement divided by the number of times the user received any sports car advertisement.

The entertainment-based server 210 converts the user events regarding the entertainment items and advertisements to implicit ratings of the entertainment items and advertisements (or advertisement categories). The entertainment-based server 210 does so using methods discussed above, or any other methods known in the art. In some embodiments, the entertainment-based server 210 normalizes/standardizes the rating values for each entertainment item and advertisement (or advertisement category) to the same scale (e.g., to have a value from 0 to 5). For example, a relatively very high click-through-rate for an advertisement may be converted to a 5 rating value whereas a 0 or relatively very low click-through-rate for an advertisement may be converted to a 0 rating value.

For a plurality of users, the entertainment-based server 210 logs and stores explicit and implicit ratings (preference information) of entertainment items and advertisements into the user log database 215 for a particular time period (e.g., one week). As shown in FIG. 2, for each user (of users 1 to N), the user log database 215 stores ratings of one or more entertainment items (e.g., entertainment items 1 to D) and ratings of one or more advertisements or advertisement categories (e.g., advertisements or advertisement categories 1 to E).

In alternative embodiments, for each user (of users 1 to N), the entertainment-based server 210 also stores in the user log database 215 one or more pieces of demographic information regarding the user (e.g., demographic information 1 to F). The demographic information may comprise any background or personal information regarding the user that is received by the entertainment-based server 210. A few examples of demographic information include place of residence, age, gender, profession, education, etc. The entertainment-based server 210 may represent different values for demographic information by rating values (i.e., derive rating values for the demographic information). For example, for place of residence, “California” may be converted to a 0 rating value and “New York” to a 5 rating value. As a further example, profession, “Teacher” may be converted to a 0 rating value and “Policeman” to a 5 rating value.

In some embodiments, the entertainment-based server 210 normalizes/standardizes the rating values for the demographic information to have the same scale as the rating values for the entertainment items and advertisements. In other embodiments, the entertainment-based server 210 weights the importance of the demographic information differently than the entertainment items by normalizing the rating values for the demographic information to have a different scale than the rating values for the entertainment items. This varies the amount of effect that the demographic information has relative to the entertainment items on the selection of advertisements to serve to a user. For example, to double the importance of the demographic information relative to the entertainment items, the scale for the demographic information may be set to double of the scale for the entertainment items (e.g., where the demographic information have normalized rating values from 0 to 10 and the entertainment items have normalized rating values from 0 to 5).

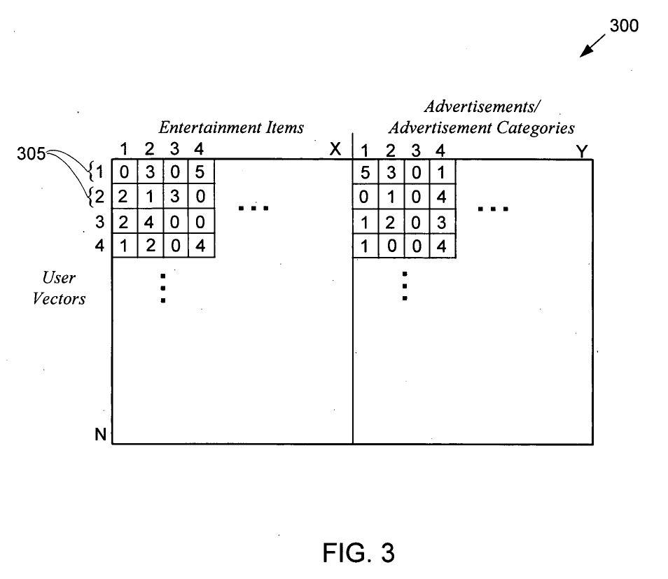

The entertainment-based server 210 uses the ratings of entertainment items and advertisements (or advertisement categories) from a plurality of previous network users stored in the user log database 215 to produce a combination model 225. The combination model comprises a plurality of user vectors, each user vector representing preference information (ratings) from a particular previous network user. In some embodiments, each user vector comprises a first component comprising ratings for one or more entertainment items and a second component comprising ratings for one or more advertisements (or advertisement categories) from a particular previous network user. FIG. 3 shows an example of a combination model 300 comprising a plurality of user vectors 305 (1 to N), each user vector 305 comprising ratings for entertainment items (1 to X) and ratings for advertisements/advertisement categories (1 to Y). In the example of FIG. 3, the ratings for entertainment items and advertisements/advertisement categories have been normalized to rating values from 0 through 5, whereas in other embodiments, a different scale is used.

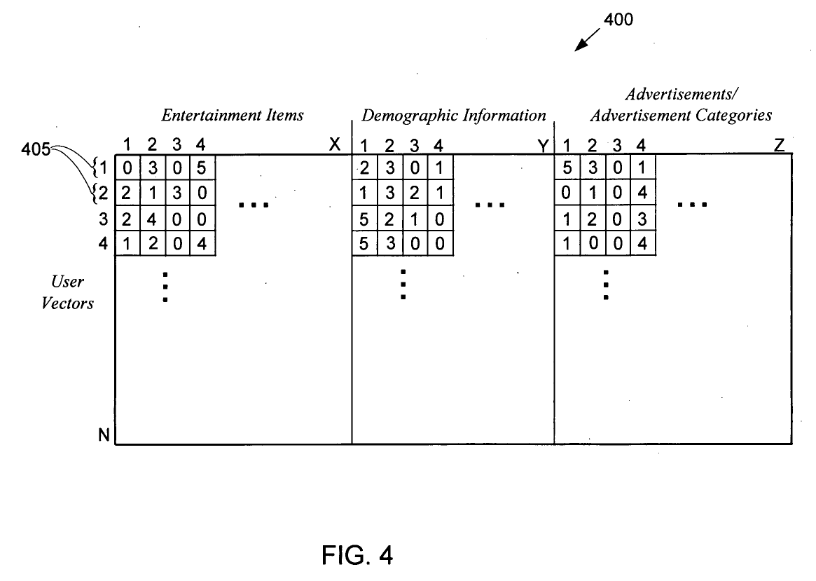

In alternative embodiments, the entertainment-based server 210 uses the ratings of entertainment items, demographic information, and advertisements/advertisement categories for a plurality of previous network users stored in the user log database 215 to produce the combination model 225. In these embodiments, each user vector comprises a first component comprising ratings for one or more entertainment items, a second component comprising ratings for one or more pieces of demographic information, and a third component comprising ratings for one or more advertisements (or advertisement categories) for a particular previous network user. FIG. 4 shows an example of a combination model 400 comprising a plurality of user vectors 405 (1 to N), each user vector 405 comprising ratings for entertainment items (1 to X), ratings for demographic information (1 to Y), and ratings for advertisements/advertisement categories (1 to Z). In the example of FIG. 4, the ratings for entertainment items, demographic information, and advertisements/advertisement categories have been normalized to rating values from 0 through 5, whereas in other embodiments, a different scale is used.

In some embodiments, the entertainment-based server 210 processes the combination model to reduce the amount of data in the combination model to make storage and usage of the combination model more efficient. In some embodiments, user vectors in the combination model may be clustered to produce a smaller number of vectors. For example, two or more user vectors having similar rating values may be represented as a single cluster vector. As another example, two or more user vectors having ratings for similar entertainment items (e.g., all songs from a same musical artist) may be represented as a single cluster vector. This may be done where there is not enough user ratings for each entertainment item individually. As further example, two or more user vectors having ratings for similar advertisements may be represented as a single cluster vector. This may be done where there is not enough user ratings for each advertisement individually.

In these embodiments, two or more user vectors having similar ratings values (for the respective entertainment items, demographic information, and advertisements), ratings on similar entertainment items, or ratings on similar advertisements, are represented by a single cluster vector comprising center rating values and variances from the center rating values. The center rating values may represent typical or average rating values for the user vectors and the variances from the center rating values may represent the standard deviation from the center rating values for the user vectors represented by the cluster vector. In other embodiments, other methods known in the art are used to reduce the amount of data in the combination model.

As described above, the combination model 225 comprises a two dimensional correlation matrix that provides correlations between user preferences/tastes regarding entertainment items (e.g., songs, films, etc.) and preferences/tastes regarding advertisements. Such correlations are useful in determining which advertisements to serve to other users during a runtime phase, especially where such advertisements are not related to entertainment items (such as advertisements for clothes, automobiles, etc.), since such correlations would otherwise not be determinable. In some embodiments, one or more advertisements/advertisement categories included in the combination model are not related (in topic or subject) to the entertainment items included in the combination model. For example, if the entertainment items comprise a plurality of Music albums, the combination model includes one or more advertisements/advertisement categories that are not related to music albums. In these embodiments, one or more of the advertisements/advertisement categories in the combination model are not entertainment advertisements/advertisement categories. As such, the combination model provides correlations between user preferences/tastes regarding entertainment items and preferences/tastes regarding advertisements/advertisement categories unrelated (in topic or subject) to entertainment items.

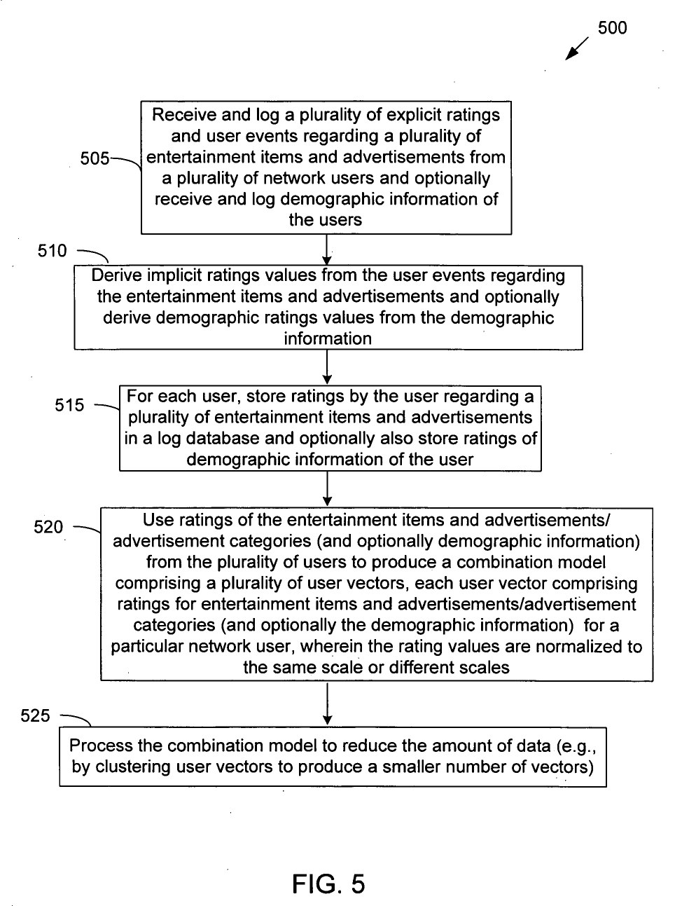

FIG. 5 is a flowchart of a method 500 for producing a combination model for selecting advertisements to serve. In some embodiments, the method 500 is implemented by software or hardware. In some embodiments, some steps of the method 500 are performed by a one or more servers and/or one or more client systems. The order and number of steps of the method 500 are for illustrative purposes only and, in other embodiments, a different order and/or number of steps are used.

The method 500 starts by receiving and logging (at 505) a plurality of explicit ratings and user events regarding a plurality of entertainment items and advertisements from a plurality of network users for a particular time period (e.g., one week). In some embodiments, the method 500 also receives and logs demographic information for the plurality of network users. Implicit ratings values are then derived (at 510) from the plurality of user events regarding the plurality of entertainment items and advertisements. In other embodiments, demographic ratings values are also derived from the demographic information. For each user in the plurality of network users, the method then stores (at 515) ratings by the user regarding a plurality of entertainment items and advertisements in a log database. In other embodiments, the method also stores ratings of demographic information of the user in the log database.

The method then uses (at 520) the ratings of the entertainment items and advertisements from the plurality of users to produce a combination model comprising a plurality of user vectors, each user vector comprising ratings for one or more entertainment items and ratings for one or more advertisements (or advertisement categories) from a particular network user. In some embodiments, the rating values for the entertainment items and advertisements are normalized to the same scale. In other embodiments, each user vector also comprises ratings for one or more pieces of demographic information for the particular network user. In some embodiments, the rating values for the entertainment items, advertisements, and demographic information are normalized to the same scale. In other embodiments, the rating values for the entertainment items and demographic information are normalized to different scales to vary the importance of the entertainment items or demographic information in selecting advertisements to serve.

The method then processes (at 525) the combination model to reduce the amount of data in the combination model. For example, the method may cluster user vectors to produce a smaller number of vectors. The method 500 then ends.

### III. Using the Combination Model for Serving Advertisements

After creating the combination model, the model can then be used to select one or more advertisements to serve to a current user of the network during a runtime phase, given some preference information (ratings) received from the current user.

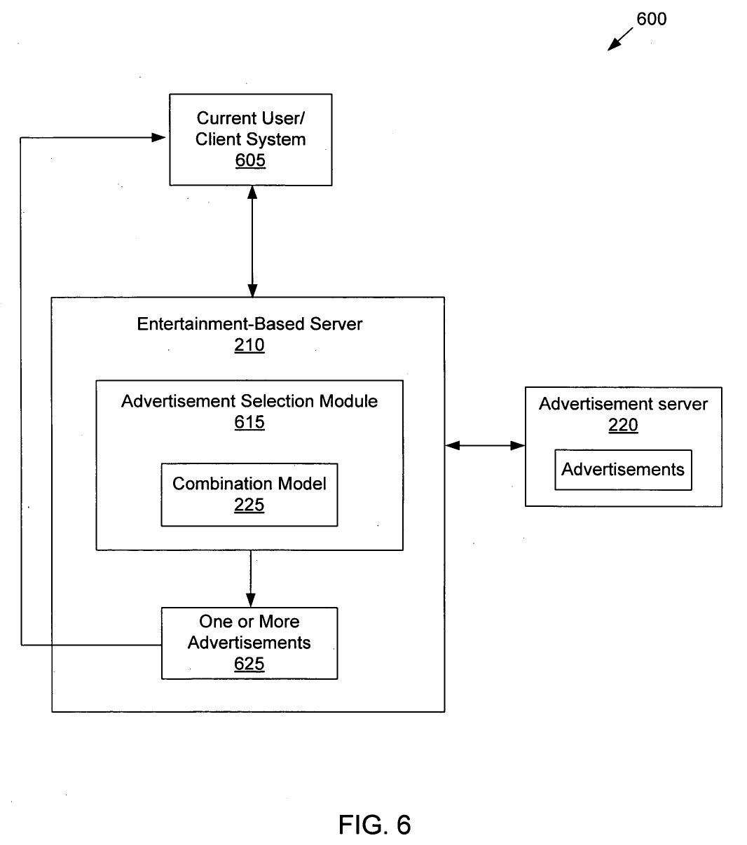

FIG. 6 is a conceptual diagram of an advertisement system 600 for implementing the combination model for serving one or more advertisements to a current network user. When a current user of a client system 605 is active on the network and interacting with a server 210, the server 210 receives explicit ratings and/or user events from the current user regarding one or more entertainment items. The server 210 may derive implicit ratings from the user events for the current user. In other embodiments, the server 210 also receives one or more pieces of demographic information from the current user and derives rating values for the one or more pieces of demographic information.

The server 210 then implements an advertisement selection module 615 that uses the combination model 225 to select one or more advertisements 625 to serve to the current user 605. The advertisement selection module 615 receives ratings of the current user of entertainment items (and in some embodiments, demographic information) and determines the advertisements 625 to serve using the received ratings and the combination model 225.

In some embodiments, to do so, the advertisement selection module 615 compares the entertainment item ratings of the current user to corresponding entertainment item ratings in the combination model. For example, if the advertisement selection module 615 received from the current user ratings for entertainment items A, C, and F, the advertisement selection module 615 compares these received rating values with ratings values for entertainment items A, C, and F in the combination model. In some embodiments, the advertisement selection module 615 uses a nearest-neighbor method to determine a user vector in the combination model having entertainment item rating values that are most similar to the corresponding entertainment item rating values of the current user. A user vector in the combination model having ratings that are most similar to the ratings of the current user is referred to herein as the representative vector. In other embodiments, other methods are used to determine the representative vector.

In other embodiments, the advertisement selection module 615 also considers and compares the demographic ratings of the current user to corresponding demographic ratings in the combination model. As such, the advertisement selection module 615 compares the entertainment item rating values and demographic rating ratings from the current user with corresponding entertainment item rating values and demographic rating values in the combination model to determine the representative vector.

In alternative embodiments, the combination model comprises a plurality of cluster vectors, each cluster vector comprising center rating values and variances from the center rating values. In these embodiments, the advertisement selection module 615 determines a cluster vector (representative vector) having entertainment item rating values (and in some embodiments, demographic rating values) that are most similar to the corresponding entertainment item rating values (and in some embodiments, demographic rating values) of the current user. The advertisement selection module 615 may do so by finding a cluster vector in the combination model having center rating values and variances from the center rating values that encompass/contains the corresponding rating values of the current user, where the corresponding rating values of the current user are within the variation (e.g., standard deviation) from the center rating values.

Once the representative vector is determined, the advertisement selection module 615 examines the advertisement/advertisement category ratings of the representative vector to determine one or more advertisements 625 to serve to the current user. For example, the advertisement selection module 615 may do so by determining the advertisements/advertisement categories having the Y highest rating values, Y being an integer equal to 1 or greater. For example, if two advertisements are to be served, the advertisement selection module 615 may determine the advertisements/advertisement categories in the representative vector having the two highest rating values.

If the representative vector comprises advertisement ratings, the advertisement selection module 615 then retrieves the one or more advertisements having the highest Y ratings from an advertisement server 220. The advertisement selection module 615 may do so using the unique identifiers associated with the one or more advertisements. If the representative vector comprises advertisement category ratings, the advertisement selection module 615 may retrieve any advertisement in the one or more advertisement categories having the highest ratings from the advertisement server 220. For example, if two advertisements are to be served and the advertisement categories having the two highest ratings are foreign car advertisements and athletic shoe advertisements, the advertisement selection module 615 may retrieve any foreign car advertisement and any athletic shoe advertisement from the advertisement server 220 to serve to the current user.

The one or more selected advertisements 625 are then served to the current user. The one or more selected advertisements 625 are the advertisements predicted by the combination model to be of interest and the most likely to be click on by the current user. In some embodiments, the one or more selected advertisements 625 are unrelated (in topic or subject) to the entertainment items rated on by the current user.

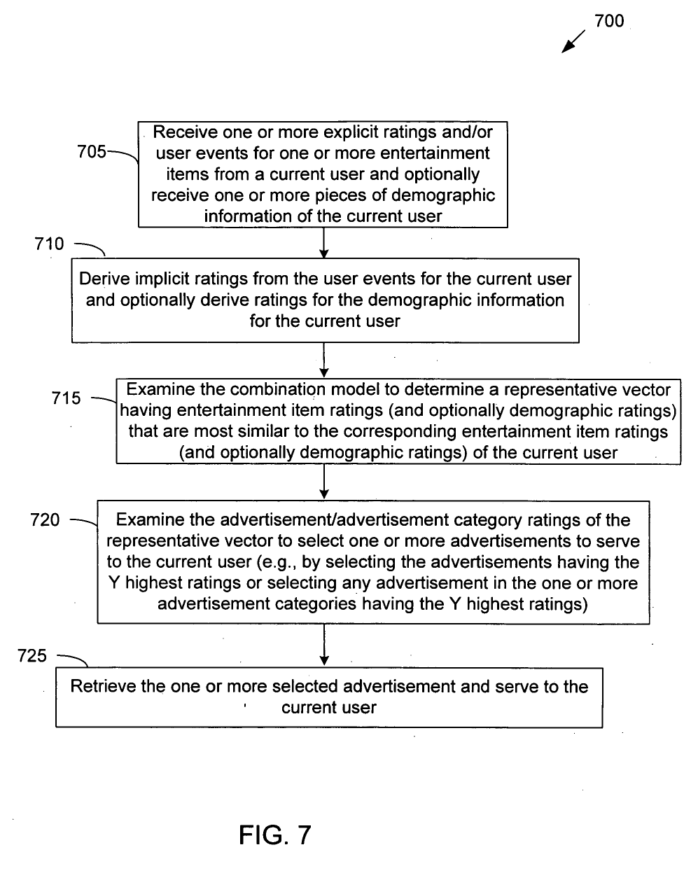

FIG. 7 is a flowchart of a method 700 for implementing the combination model for serving one or more advertisements to a current network user. In some embodiments, the method 700 is implemented by software or hardware. In some embodiments, some steps of the method 700 are performed by one or more servers and/or one or more client systems. The order and number of steps of the method 700 are for illustrative purposes only and, in other embodiments, a different order and/or number of steps are used.

Generally, the method 700 implements a collaborative-filtering based advertisement system for serving one or more advertisements to a current user of a network by determining one or more ratings (explicit or implicit) of one or more entertainment items from the current user and selecting the advertisements to serve using the one or more ratings of the current user and the combination model. In some embodiments, the method also determines one or more pieces of demographic information of the current user and uses the demographic information to select the advertisements to serve.

The method 700 starts when one or more explicit ratings and/or user events are received (at 705) for one or more entertainment items from a current user (of a client system) that is active on a network and interacting with a server. The method then derives (at 710) implicit ratings from the user events for the current user. In other embodiments, the method 700 also receives (at 705) one or more pieces of demographic information of the current user and derives (at 710) rating values for the one or more pieces of demographic information.

Using the ratings of one or more entertainment items from the current user, the method then implements (at 715 and 720) a combination model to select one or more advertisements to serve to the current user. In some embodiments, the combination model comprises a plurality of user or cluster vectors, each vector comprising ratings for one or more entertainment items and one or more advertisements (or advertisement categories). The method examines the combination model to determine (at 715) a user or cluster vector (representative vector) having entertainment item ratings that are most similar to the corresponding entertainment item ratings of the current user. In other embodiments, each vector in the combination model comprises ratings for one or more entertainment items, one or more pieces of demographic information, and one or more advertisements (or advertisement categories). In these embodiments, the method determines (at 715) a vector (representative vector) having entertainment item and demographic ratings that are most similar to the corresponding entertainment item and demographic ratings of the current user.

Once the representative vector is determined, the method then examines (at 720) the advertisement/advertisement category ratings of the representative vector to select one or more advertisements 625 to serve to the current user. If the representative vector comprises advertisement ratings, the method 700 selects the one or more advertisements having the Y highest ratings. If the representative vector comprises advertisement category ratings, the method selects any advertisement in the one or more advertisement categories having the Y highest ratings.

The method then retrieves (at 725) the one or more selected advertisement from the advertisement server 220 and serves the one or more selected advertisements to the current user. In some embodiments, the one or more advertisements served to the current user are unrelated (in topic or subject) to the entertainment items rated on by the current user. The method 700 then ends.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for implementing a collaborative-filtering based advertisement system for serving one or more advertisements to a current user of a network, the method comprising:
determining a rating of at least one entertainment item from the current user; and
selecting the one or more advertisements to serve to the current user using the at least one rating of the current user and a model based on ratings of a plurality of entertainment items and a plurality of advertisements from a plurality of previous network users.

2. The method of claim 1, wherein:
the model comprises a plurality of vectors, each vector comprising a rating of at least one entertainment item and a rating of at least one advertisement from a previous network user; and
selecting the one or more advertisements comprises:
determining a representative vector in the model having a corresponding rating of the at least one entertainment item that is most similar to the rating of the at least one entertainment item from the current user; and
examining a rating of the at least one advertisement in the representative vector to select the one or more advertisements.

3. The method of claim 1, wherein:
the model comprises a plurality of cluster vectors, each cluster vector comprising a center rating of at least one entertainment item, a variation from the center rating of the at least one entertainment item, and a center rating of at least one advertisement, each cluster vector representing ratings from two or more previous network users; and
selecting the one or more advertisements comprises:
determining a representative cluster vector in the model comprising a corresponding center rating of the at least one entertainment item and a variation from the center rating of the at least one entertainment item that contains the rating of the at least one entertainment item from the current user; and
examining a center rating of the at least one advertisement in the representative cluster vector to select the one or more advertisements.

4. The method of claim 1, wherein an entertainment item comprises items related to music, music videos, television programs, radio programs, movies, or video games.

5. The method of claim 1, wherein the one or more selected advertisements are not related in topic or subject to an entertainment item.

6. The method of claim 1, wherein:
a rating comprises an explicit rating or an implicit rating derived from a user event.

7. The method of claim 1, wherein:
the ratings of the plurality of entertainment items and the plurality of advertisements from the plurality of previous network users are normalized to a same scale.

8. The method of claim 1, further comprising determining at least one piece of demographic information of the current user, wherein:
the model is further based on demographic information of the plurality of previous network users; and
selecting the one or more advertisements comprises using the at least one piece of demographic information of the current user, the rating of the at least one entertainment item from the current user, and the model to select the one or more advertisements to serve to the current user.

9. A computer readable medium having instructions stored thereon when executed, implement a collaborative-filtering based advertisement system for serving one or more advertisements to a current user of a network, the computer readable medium comprising sets of instructions for:
determining a rating of at least one entertainment item from the current user; and
selecting the one or more advertisements to serve to the current user using the at least one rating of the current user and a model based on ratings of a plurality of entertainment items and a plurality of advertisements from a plurality of previous network users.

10. The computer readable medium of claim 9, wherein:
the model comprises a plurality of vectors, each vector comprising a rating of at least one entertainment item and a rating of at least one advertisement from a previous network user; and
the set of instructions for selecting the one or more advertisements comprises sets of instructions for:
determining a representative vector in the model having a corresponding rating of the at least one entertainment item that is most similar to the rating of the at least one entertainment item from the current user; and
examining a rating of the at least one advertisement in the representative vector to select the one or more advertisements.

11. The computer readable medium of claim 9, wherein:
the model comprises a plurality of cluster vectors, each cluster vector comprising a center rating of at least one entertainment item, a variation from the center rating of the at least one entertainment item, and a center rating of at least one advertisement, each cluster vector representing ratings from two or more previous network users; and
the set of instructions for selecting the one or more advertisements comprises sets of instructions for:
determining a representative cluster vector in the model comprising a corresponding center rating of the at least one entertainment item and a variation from the center rating of the at least one entertainment item that contains the rating of the at least one entertainment item from the current user; and
examining a center rating of the at least one advertisement in the representative cluster vector to select the one or more advertisements.

12. The computer readable medium of claim 9, wherein an entertainment item comprises items related to music, music videos, television programs, radio programs, movies, or video games.

13. The computer readable medium of claim 9, wherein the one or more selected advertisements are not related in topic or subject to an entertainment item.

14. The computer readable medium of claim 9, wherein:
a rating comprises an explicit rating or an implicit rating derived from a user event.

15. The computer readable medium of claim 9, wherein:
the ratings of the plurality of entertainment items and the plurality of advertisements from the plurality of previous network users are normalized to a same scale.

16. The computer readable medium of claim 9, further comprising a set of instructions for determining at least one piece of demographic information of the current user, wherein:
the model is further based on demographic information of the plurality of previous network users; and
the set of instructions for selecting the one or more advertisements comprises a set of instructions for using the at least one piece of demographic information of the current user, the rating of the at least one entertainment item from the current user, and the model to select the one or more advertisements to serve to the current user.

17. A system for implementing a collaborative-filtering based advertisement system for serving one or more advertisements to a current user of a network, the system comprising
a module configured for:
determining a rating of at least one entertainment item from the current user; and
selecting the one or more advertisements to serve to the current user using the at least one rating of the current user and a model based on ratings of a plurality of entertainment items and a plurality of advertisements from a plurality of previous network users.

18. The system of claim 17, wherein:
the model comprises a plurality of vectors, each vector comprising a rating of at least one entertainment item and a rating of at least one advertisement from a previous network user; and
the module is configured to select the one or more advertisements by:
determining a representative vector in the model having a corresponding rating of the at least one entertainment item that is most similar to the rating of the at least one entertainment item from the current user; and
examining a rating of the at least one advertisement in the representative vector to select the one or more advertisements.

19. The system of claim 17, wherein:
the model comprises a plurality of cluster vectors, each cluster vector comprising a center rating of at least one entertainment item, a variation from the center rating of the at least one entertainment item, and a center rating of at least one advertisement, each cluster vector representing ratings from two or more previous network users; and
the module is configured to select the one or more advertisements by:
determining a representative cluster vector in the model comprising a corresponding center rating of the at least one entertainment item and a variation from the center rating of the at least one entertainment item that contains the rating of the at least one entertainment item from the current user; and
examining a center rating of the at least one advertisement in the representative cluster vector to select the one or more advertisements.

20. The system of claim 17, wherein an entertainment item comprises items related to music, music videos, television programs, radio programs, movies, or video games.

21. The system of claim 17, wherein the one or more selected advertisements are not related in topic or subject to an entertainment item.

22. The system of claim 17, wherein:
a rating comprises an explicit rating or an implicit rating derived from a user event.

23. The system of claim 17, wherein:
the ratings of the plurality of entertainment items and the plurality of advertisements from the plurality of previous network users are normalized to a same scale.

24. The system of claim 17, wherein:
the module is further configured for determining at least one piece of demographic information of the current user;
the model is further based on demographic information of the plurality of previous network users; and
the module is configured to select the one or more advertisements by using the at least one piece of demographic information of the current user, the rating of the at least one entertainment item from the current user, and the model to select the one or more advertisements to serve to the current user.
